(19) United States
(12) Patent Application Publication
(10) Pub. No.: US 2016/0347528 A1
(43) Pub. Date: Dec. 1, 2016

(54) Instrumental Gas Mattress and Instrumental Bag Assembly

(71) Applicant: Chi-Yuan Ning, New Taipei City (TW)

(72) Inventor: Chi-Yuan Ning, New Taipei City (TW)

(21) Appl. No.: 14/788,873

(22) Filed: Jul. 1, 2015

(30) Foreign Application Priority Data
May 28, 2015 (TW) 104208333

(51) Int. Cl. B65D 81/05; B32B 27/08; G10G 7/00

(52) U.S. Cl. CPC B65D 81/052; G10G 7/005; B32B 27/08; B32B 2307/51; B32B 2553/02; B32B 2439/00

(57) ABSTRACT

An instrumental gas mattress uses gas to buffer outside impact so as to prevent damage to the instrument. The entire weight is greatly reduced to 7 to 10 kg compared to the conventional bag assembly with using polyurethane foam. The present invention provides a bag for kinds of instruments with well protection ability which is super light weight. The instrumental gas mattress may contain inert gas that is stable and lighter than the air, such as helium gas, to reduce weight and to prevent the gas from combustion. The instrumental gas mattress may be folded with minimum side with using the valve to release gas therein. User may pump gas into the instrumental gas mattress with required hardness by controlling the quantity of the gas.

### BACKGROUND OF THE INVENTION

1. Field of Invention

This invention relates to an instrumental gas mattress and an instrumental bag assembly and more particularly to an instrumental gas mattress and an instrumental bag assembly to buffer impact that may damage an instrument therein.

2. Description of the Related Art

With regard to instruments, especially for electric instruments, a guitar, a bass or an effect processor, preciseness of strings, completeness of a chamber, effect pedals and electronic parts are keys to beautiful sounds of the instruments. The instruments are fragile and how to perfectly protect the instruments during transportation is an essential issue for music players. Any impact during the transportation may cause damage to the instruments.

In general, the instrument is placed in a conventional instrumental bag assembly. The instrumental bag assembly has a bag and a buffer material mounted in the bag. The buffer material is plastic cushions/polyurethane foam, which is used to protect the instrument during the transportation from damage. However, the material of the buffer material is still too heavy and is not easy for a music player to carrier with. Some conventional instrumental bags try to reduce thicknesses of the buffer material so as to reduce total weight of the conventional instrumental bag, however, conventional instrumental bags with thinner buffer material provide less protection to the instruments.

### SUMMARY OF THE INVENTION

In order to solve the disadvantages and shortcomings of the conventional instrumental bag assembly, the present invention provides an instrumental gas mattress which is lighter but is able to provide a better protection to the instruments.

An instrumental gas mattress has a main body and multiple connected portions. The main body is hollow and has two non-ventilated elastic pads and a space. Each elastic pad has a shape, a periphery and an inner surface. The two shapes correspond to each other and each shape corresponds to an instrument. The two peripheries are securely connected to each other. The two inner surfaces face each other. The space is formed between the two elastic pads to contain gas. Each connected portion is formed at a position where parts of the two inner surfaces of the two elastic pads are securely connected to each other.

Preferably, each connected portion is a strip. The gas is air or inert gas lighter than the air. Each elastic pad is made from natural rubber, artificial rubber, latex, Polyethylene, Polyvinyl Chloride, Polystyrene, Ethylene vinyl Acetate, or Polypropylene.

Preferably, each connected portion is round. The gas is air or helium gas. Each elastic pad is made from natural rubber, artificial rubber, latex, Polyethylene, Polyvinyl Chloride, Polystyrene, Ethylene vinyl Acetate, or Polypropylene.

Preferably, the instrumental gas mattress further has a valve securely mounted on the main body.

The present invention tends to provide an instrumental bag assembly.

An instrumental bag assembly has a bag and an instrumental gas mattress. The bag has a room formed in the bag. The instrumental gas mattress is mounted in the room and has a main body and multiple connected portions. The main body is hollow and has two non-ventilated elastic pads and a space. Each elastic pad has a shape, a periphery and an inner surface. The two shapes correspond to each other and each shape corresponds to an instrument. The two peripheries are securely connected to each other. The two inner surfaces face each other. The space is formed between the two elastic pads to contain gas. Each connected portion is formed at a position where parts of the two inner surfaces of the two elastic pads are securely connected to each other. Preferably, each connected portion is a strip. The gas is air or helium gas. Each elastic pad is made from natural rubber, artificial rubber, latex, Polyethylene, Polyvinyl Chloride, Polystyrene, Ethylene vinyl Acetate, or Polypropylene.

Preferably, each connected portion is round. The gas is air or helium gas. Each elastic pad is made from natural rubber, artificial rubber, latex, Polyethylene, Polyvinyl Chloride, Polystyrene, Ethylene vinyl Acetate, or Polypropylene.

Preferably, the instrumental gas mattress further has a valve securely mounted on the main body.

Thus, the present invention achieves advantages as below.

1. The instrumental gas mattress in accordance with the present invention uses gas to buffer outside impact so as to prevent damage to the instrument. The entire weight is greatly reduced to 7 to 10 kg compared to the conventional bag assembly with using polyurethane foam. Thus, the present invention is able to provide a perfect protection to the instruments without increase weight of the bag. No extra load is putted on user during transportation.

2. The present invention provide a bag for kinds of instruments with well protection ability which is super light weight. Compared to the conventional solid buffer materials or a hard case, the instrumental gas mattress in accordance with the present invention can greatly reduce the entire weight and an instrumentalist's load. The strength of the bag is selectable from quantity of the gas loaded therein. The present invention may be stronger than the conventional bag with foam material loaded, since the instrumental gas mattress may be fully pumped to provide a strength of the bag.

3. The instrumental gas mattress is able to adsorb impact forces from a better deformability compared foam materials of the conventional bag.

4. The instrumental gas mattress may contain inert gas that is stable and lighter than the air, such as helium gas, to reduce weight and to prevent the gas from combustion.

5. The instrumental gas mattress may be folded with minimum side with using the valve to release gas therein. User may pump gas into the instrumental gas mattress with required hardness by controlling the quantity of the gas.

### BRIEF DESCRIPTION OF THE DRAWINGS

FIG. 1 is a side view of a first embodiment of an instrumental gas mattress in accordance with the present invention;

FIG. 2 is an enlarged cross sectional view in partial section of the instrumental gas mattress along an A-A line in FIG. 1;

FIG. 3 is a side view of a second embodiment of an instrumental gas mattress in accordance with the present invention;

FIG. 4 is a side view of a third embodiment of an instrumental gas mattress in accordance with the present invention;

FIG. 5 is an enlarged view of a valve of the instrumental gas mattress in FIG. 4;

FIG. 6 is a side view of a fourth embodiment of an instrumental gas mattress in accordance with the present invention;

FIG. 7 is an enlarged view of a valve of the instrumental gas mattress in FIG. 6;

FIG. 8 is a front view of an instrumental bag assembly in accordance with the present invention;

FIG. 9 is a rear view of the instrumental bag assembly in FIG. 8;

FIG. 10 is an inside view of the instrumental bag assembly in FIG. 8;

FIG. 11 is a partially cross sectional front view of the instrumental gas mattress in FIG. 8; and

FIG. 12 is a partially cross sectional rear view of the instrumental gas mattress in FIG. 8.

### DETAILED DESCRIPTION OF THE INVENTION

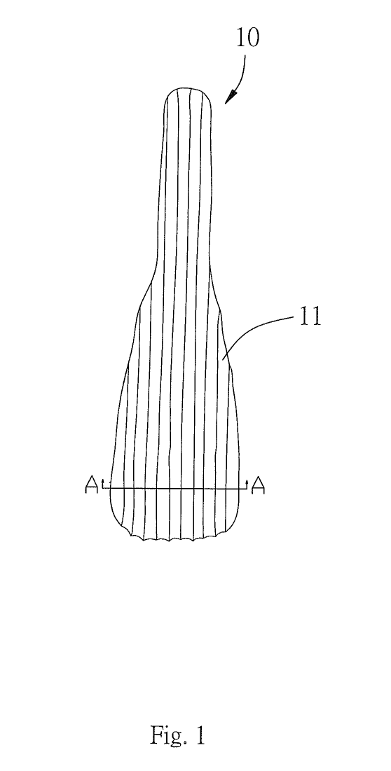

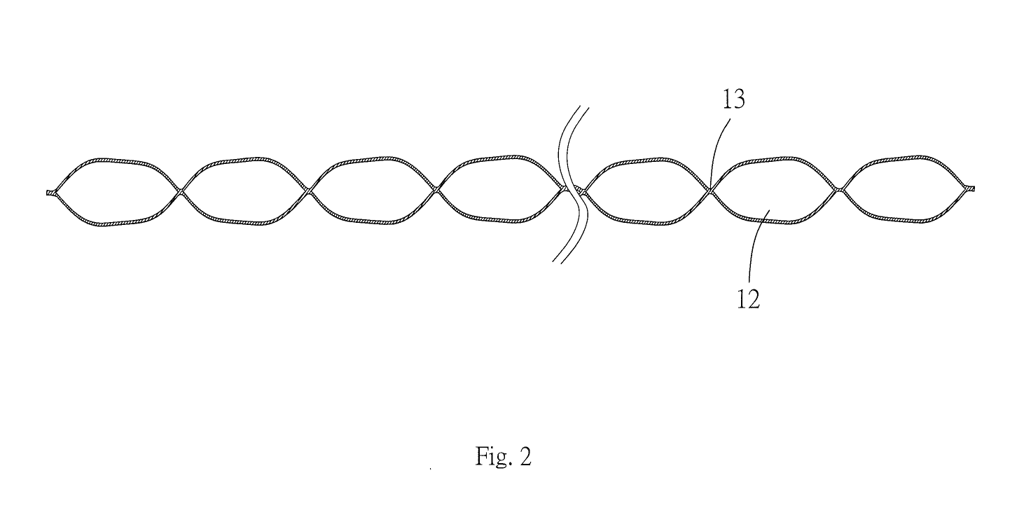

With reference to FIGS. 1 and 2, a first embodiment of an instrumental gas mattress in accordance with the present invention is used to protect an instrument like guitar, and has a hollow main body 10 and multiple connected portions 13.

The main body 10 has two non-ventilated elastic pads 11 and a space 12. Preferably, each elastic pad 11 is made from plastic or rubber. Each elastic pad 11 has an upper portion, a lower portion, a shape, a periphery and an inner surface. The upper portion of each elastic pad 11 is narrower than the lower portion of the elastic pad 11. The two shapes correspond to each other and each shape corresponds to an instrument. The two peripheries are securely connected to each other. The two inner surfaces face each other.

The space 12 of the main body 10 is formed between the two elastic pads 11 to contain gas. Each elastic pad 11 may be made from natural rubber, artificial rubber, latex, Polyethylene Chloride, Polystyrene, Ethylene vinyl Acetate, or Polypropylene. The gas may be air or inert gas lighter than the air, such as helium gas, to reduce more weight and to prevent the leaking gas from combustion.

Each connected portion 13 is formed at a position where parts of the two inner surfaces of the two elastic pads 11 are securely connected to each other. The connected portions 13 can prevent the main body 10 from being too swollen to use when the main body 10 is being inflated. With reference to FIG. 1, each connected portion 13 is a strip and is formed at the main body 10 in a hot-pressing method. Therefore, multiple parts of the two inner surfaces of the two elastic pads 11 are connected, and the space 12 of the main body 10 are divided into multiple long and narrow zones. Two ends of each connected portions 13 are connected with the peripheries of the elastic pads 11.

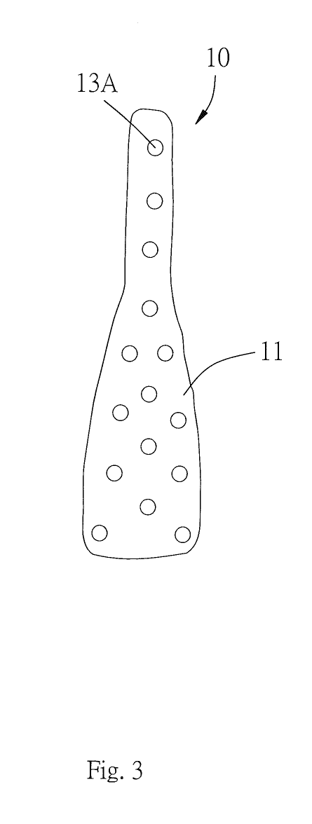

With reference to FIG. 3, a second embodiment of the instrumental gas mattress is substantially the same as the first embodiment. However, the connected portions 13A may be any shape, such as round in FIG. 3, or pentagonal, or hexagonal.

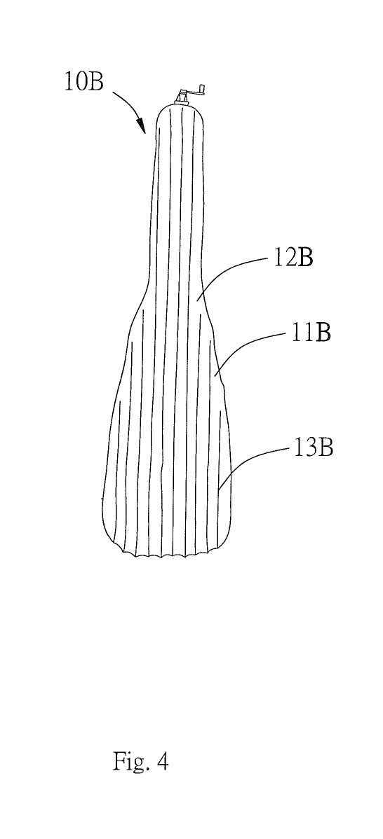

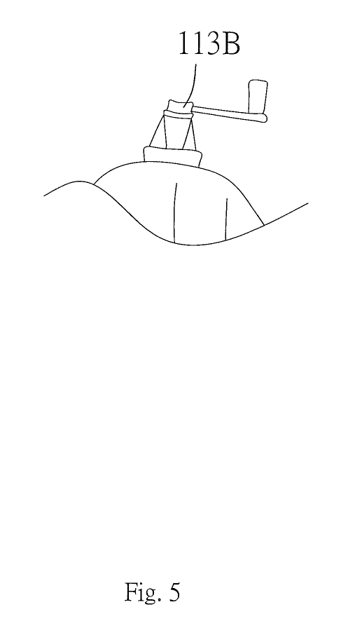

With reference to FIGS. 4 and 5, a third embodiment of the instrumental gas mattress in accordance with the present invention is substantially the same as the first embodiment. However, the third embodiment further has a valve 113B securely mounted on the main body 10. Further, one end of each connected portion 13B is connected with the peripheries of the elastic pads 11B, but the other end of the connected portion 13B is not. Therefore, gas can flow in the space 12B and be fully inflated into the space 12B of the main body 10B. The valve 113B is used to control the volume of the gas in the main body 10B. If the main body 10B is in a gas-saturation state, the main body 10B can have a good buffer and protective effect. If some gas leaks from the main body 10B via the valve 113B, the main body 10B is more elastic than being in a gas-saturated state, and can adsorb a hit. If all of the gas leaks from the main body 10B via the valve 113B, the main body 10B can be folded up or rolled up.

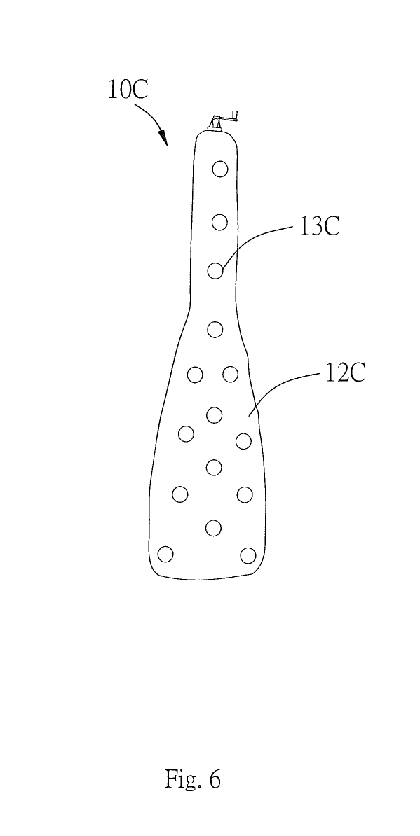

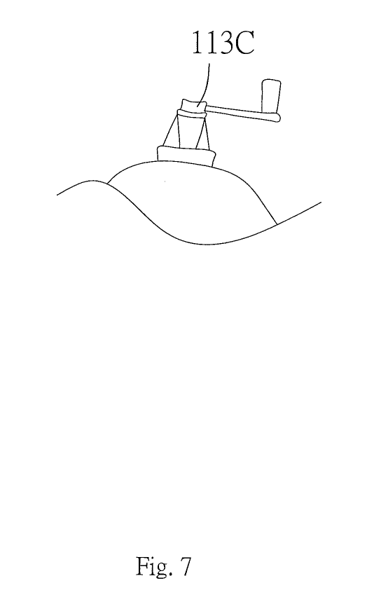

With reference to FIGS. 6 and 7, a fourth embodiment of the instrumental gas mattress in accordance with the present invention is substantially the same as the second embodiment. However, the fourth embodiment further has a valve 113C securely mounted on the main body 10C. Because each connected portion 13C is round, gas can flow in the space 12C and be fully inflated into the space 12C of the main body 10C.

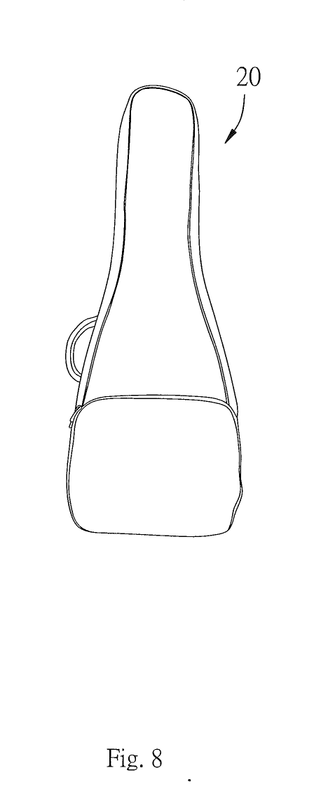

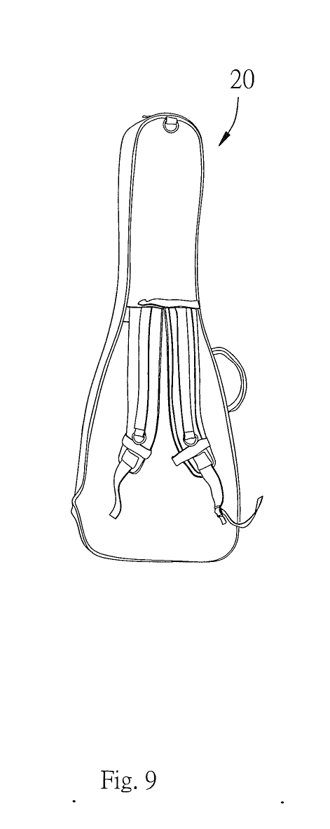

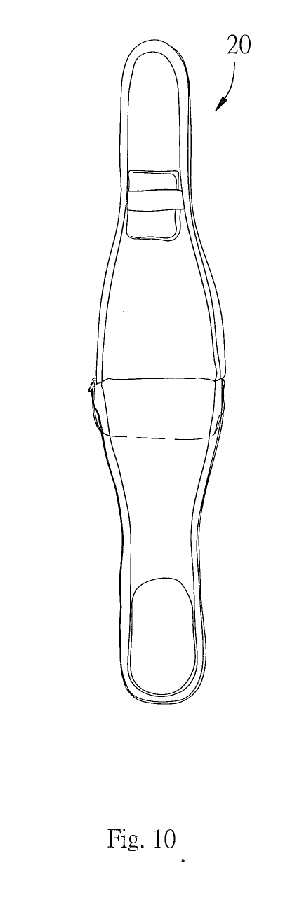

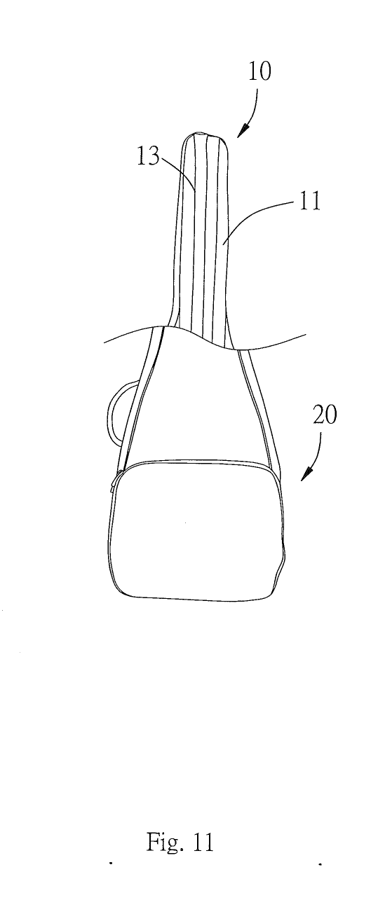

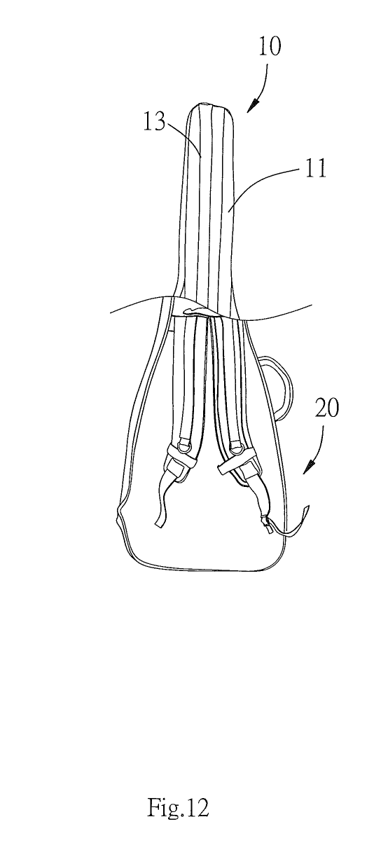

With reference to FIGS. 8-12, an instrumental bag assembly 20 in accordance to the present invention is used to protect an instrument, such as a guitar, a bass, or an effect processor and prevents it from dust or a hit. The bag assembly 20 has a room. Conventionally, the room is used to contain conventional buffer materials, such as polyurethane foam or plastic cushions. However, the room contains the first embodiment of the instrumental gas mattress in accordance with the present invention, instead of conventional buffer materials. Because the present invention uses gas, instead of solid materials, the entire weight is greatly reduced and the present invention can greatly reduce an instrumentalist's load during transportation.

Then, the first embodiment is replaced with the third embodiment. Because the valve 113B is mounted on a top of the main body 10B of the instrumental gas mattress, a user can merely open a top of the instrumental bag assembly 20 and directly reach for the valve 113B to control amount of the gas, instead of taking out the entire instrumental gas mattress. This is very convenient.

What is claimed is:

1. An instrumental gas mattress having:
a hollow main body having
two non-ventilated elastic pads, each elastic pad having
a shape, the two shapes corresponding to each other and each shape corresponding to an instrument;
a periphery, the two peripheries securely connected to each other; and
an inner surface, the two inner surfaces facing each other; and
a space formed between the two elastic pads to contain gas; and
multiple connected portions, each connected portion formed at a position where parts of the two inner surfaces of the two elastic pads are securely connected to each other.

2. The instrumental gas mattress as claimed in claim 1, wherein
each connected portion is a strip;
the gas is air or inert gas lighter than the air; and
each elastic pad is made from natural rubber, artificial rubber, latex, Polyethylene, Polyvinyl Chloride, Polystyrene, Ethylene vinyl Acetate, or Polypropylene.

3. The instrumental gas mattress as claimed in claim 1, wherein
each connected portion is round;
the gas is air or helium gas; and
each elastic pad is made from natural rubber, artificial rubber, latex, Polyethylene, Polyvinyl Chloride, Polystyrene, Ethylene vinyl Acetate, or Polypropylene.

4. The instrumental gas mattress as claimed in claim 1, wherein the instrumental gas mattress further has a valve securely mounted on the main body.

5. The instrumental gas mattress as claimed in claim 2, wherein the instrumental gas mattress further has a valve securely mounted on the main body.

6. The instrumental gas mattress as claimed in claim 3, wherein the instrumental gas mattress further has a valve securely mounted on the main body.

7. An instrumental bag assembly having
a bag having
a room formed in the bag; and
an instrumental gas mattress mounted in the room and having
a hollow main body having
two non-ventilated elastic pads, each elastic pad having
a shape, the two shapes corresponding to each other and each shape corresponding to an instrument;
a periphery, the two peripheries securely connected to each other; and
an inner surface, the two inner surfaces facing each other; and
a space formed between the two elastic pads to contain gas; and
multiple connected portions, each connected portion formed at a position where parts of the two inner surfaces of the two elastic pads are securely connected to each other.

8. The instrumental bag assembly as claimed in claim 7, wherein
each connected portion is a strip;
the gas is air or helium gas; and
each elastic pad is made from natural rubber, artificial rubber, latex, Polyethylene, Polyvinyl Chloride, Polystyrene, Ethylene vinyl Acetate, or Polypropylene.

9. The instrumental bag assembly as claimed in claim 7, wherein
each connected portion is round;
the gas is air or helium gas; and
each elastic pad is made from natural rubber, artificial rubber, latex, Polyethylene, Polyvinyl Chloride, Polystyrene, Ethylene vinyl Acetate, or Polypropylene.

10. The instrumental bag assembly as claimed in claim 7, wherein the instrumental gas mattress further has a valve securely mounted on the main body.

11. The instrumental bag assembly as claimed in claim 8, wherein the instrumental gas mattress further has a valve securely mounted on the main body.

12. The instrumental bag assembly as claimed in claim 9, wherein the instrumental gas mattress further has a valve securely mounted on the main body.
